(19) United States
(12) Patent Application Publication
(10) Pub. No.: US 2008/0019708 A1
(43) Pub. Date: Jan. 24, 2008

(54) Image recording medium and method and apparatus for producing the same

(76) Inventors: Takashi Sakamaki, Ebina-shi (JP); Reki Nakamura, Sagamihara-shi (JP); Mikio Ishibashi, Yokohama-shi (JP); Kazuhisa Sudo, Kawasaki-shi (JP); Yukiko Iwasaki, Yokohama-shi (JP); Masafumi Yamada, Kawasaki-shi (JP); Megumi Ohtoshi, Kawasaki-shi (JP); Nobuyuki Koinuma, Yokohama-shi (JP); Kazuhiko Yuki, Kawasaki-shi (JP)

Correspondence Address: HARNESS, DICKEY & PIERCE, P.L.C., P.O. BOX 8910, RESTON, VA, 20195, US

(21) Appl. No.: 11/826,715

(22) Filed: Jul. 18, 2007

(30) Foreign Application Priority Data
Jul. 18, 2006 (JP) JP 2006-196028

(51) Int. Cl. G11B 7/24; G03G 15/00

(52) U.S. Cl. 399/2; 430/270.11

(57) ABSTRACT

An image recording medium includes a first sheet and a second sheet. The first sheet further includes a transparent portion having a transparent adhesive layer on which a mirror image of an original image is formed. The second sheet is formed of non-transparent material having a color distinguishable from a color of the mirror image. The second sheet is overlaid on the transparent adhesive layer, having the mirror image formed thereon, of the first sheet.

### PRIORITY STATEMENT

The present patent application claims priority under 35 U.S.C. §119 upon Japanese patent application, No. 2006-196028 filed on Jul. 18, 2006 in the Japan Patent Office, the entire content of which is hereby incorporated herein by reference.

### BACKGROUND

Image forming apparatuses include a printer, a copier, a facsimile machine, a multi-function device thereof. For such image forming apparatuses, various methods have been proposed to obtain a glossy photographic image on a recording medium.

For example, a conventional image forming apparatus uses a particular toner to obtain a glossy image on a recording medium. Such an image forming apparatus first forms a toner image on a surface of a recording medium in a conventional manner. Before the recording medium reaches a fixing device, a layer of specific transparent toner is uniformly formed all over the surface of the recording medium. The first toner image and the transparent toner layer are fixed on the recording medium by the fixing device. Thus, a relatively high glossy image may be obtained.

However, such an image forming apparatus employing a specific toner is not so advantageous in that a particular developing device capable of developing an image with the transparent toner is needed besides typical developing devices and in that a difference in thickness of toner between an image area and a non-image area may impose a relatively high load on the fixing device.

Alternatively, a conventional image forming apparatus employs a specific recording medium to obtain a glossy image thereon. For example, a specific recording medium is provided with a thermoplastic resin layer on each side thereof. When fixing an image on the recording medium in a typical manner, an image forming apparatus applies pressure and heat to the image on the recording medium, thereby providing a uniform glossy surface to the image.

However, the above-described method needs to employ the above-described recording medium along with a specific fixing device to obtain a sufficiently glossy image. Therefore, such an image forming apparatus using a specific recording medium is not so advantageous in terms of apparatus construction, manufacturing cost, and/or power consumption.

Further, a conventional image forming apparatus employs a plurality of fixing devices to obtain a glossy image on a recording medium. Such an image forming apparatus includes a first fixing device for fixing an unfixed toner image on a recording sheet, and a second fixing device to fix the fixed toner image on the recording sheet. An image forming apparatus may be configured so that a user may select a mode of using only the first fixing device or a mode of using both the first and second fixing devices.

However, such an image forming apparatus employing a plurality of fixing device is also not so advantageous in terms of apparatus construction, manufacturing cost, and/or power consumption.

### SUMMARY

At least one embodiment of the present specification provides an image recording medium including a first sheet and a second sheet. The first sheet further includes a transparent portion having a transparent adhesive layer on which a mirror image of an original image is formed. The second sheet is formed of non-transparent material having a color distinguishable from a color of the mirror image. The second sheet is overlaid on the transparent adhesive layer, having the mirror image formed thereon, of the first sheet.

Additional features and advantages will be more fully apparent from the following detailed description of example embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1a to 1d are plan views illustrating configuration examples of a first sheet partially having a transparent portion;

FIGS. 2a to 2d schematically illustrate (according to at least one example embodiment) a process of producing an image recording medium including a glossy photographic image and freely writable area;

FIGS. 3a to 3d schematically illustrate (according to at least one example embodiment) a process of producing an image recording medium including a glossy photographic image using a toner transfer technology when a first sheet is totally transparent;

FIGS. 4a to 4d schematically illustrate (according to at least one example embodiment) a process of producing an image recording medium including a glossy photographic image using a toner transfer technology when a first sheet is partially transparent;

FIGS. 5a and 5b illustrate a process of producing an image recording medium including a color image by applying pressure without heating in a color image forming apparatus;

FIGS. 6a and 6b illustrate (according to at least one example embodiment) a process of producing an image recording medium including a glossy photographic image by applying pressure and heating in a color image forming apparatus;

FIG. 7 is a schematic view illustrating an example configuration of an electrophotographic image forming apparatus according to at least one example embodiment;

FIG. 8 is a flow chart illustrating (according to at least one example embodiment) an image forming process to be executed by a program implemented in a controller of an image forming apparatus;

FIGS. 9a to 9d illustrate (according to at least one example embodiment) a process of producing an image recording medium including a glossy photographic image using an inkjet printing technology when a first sheet is totally transparent;

FIGS. 10a and 10d illustrate (according to at least one example embodiment) a process of producing an image recording medium including a glossy photographic image using an inkjet printing technology when a first sheet is partially transparent;

FIG. 11 is a side view illustrating (according to at least one example embodiment) an image forming apparatus using an inkjet printing technology; and

FIG. 12 is a plan view illustrating image forming devices included in the image forming apparatus of FIG. 11.

The accompanying drawings are intended to depict example embodiments of the present patent application and should not be interpreted to limit the scope thereof. The accompanying drawings are not to be considered as drawn to scale unless explicitly noted.

### DETAILED DESCRIPTION OF EXAMPLE EMBODIMENTS

It will be understood that if an element or layer is referred to as being “on”, “against”, “connected to” or “coupled to” another element or layer, then it can be directly on, against, connected or coupled to the other element or layer, or intervening elements or layers may be present. In contrast, if an element is referred to as being “directly on”, “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath”, “below”, “lower”, “above”, “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

Although the terms first, second, etc. may be used herein to describe various elements, components, regions, layers and/or sections, it should be understood that these elements, components, regions, layer and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present application.

The terminology used herein is for the purpose of describing particular embodiments only and is not intended to be limiting of the present application. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this application is not intended to be limited to the specific terminology so selected and it is to be understood that each specific element includes all technical equivalents that operate in a similar manner.

In the present application, the term image recording medium is intended to cover, among other things, a medium capable of retaining or containing an image or images or a medium with an image or images stored thereon.

Referring now to the drawings, wherein like reference numerals designate identical or corresponding parts throughout the several views, example embodiments are described. However, the present application is not limited to the example embodiments as illustrated in the drawings.

According to an example embodiment, an image recording medium 200 includes a first sheet 21 and a second sheet 22. The first sheet 21 has a transparent portion 21a, which is partially provided on the first sheet 21. An image forming side of the transparent portion 21a is covered by a transparent adhesive layer.

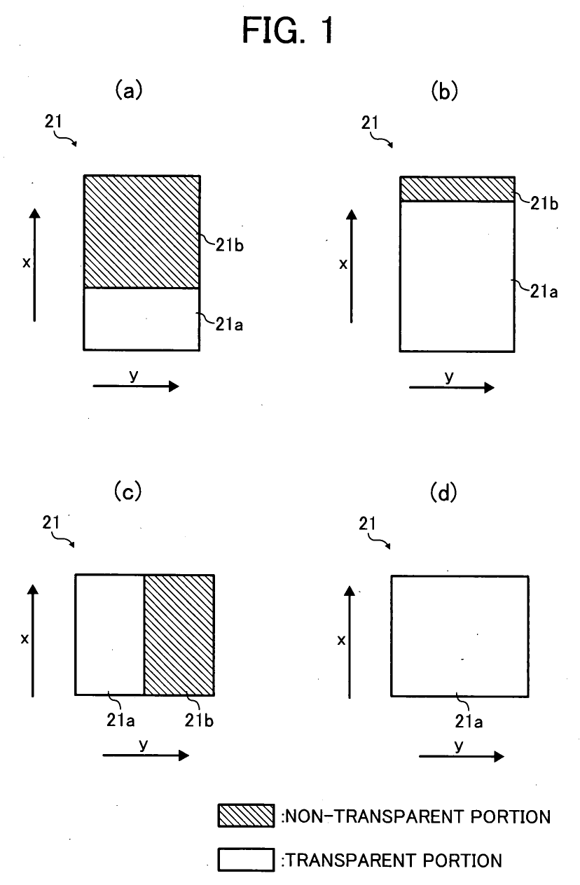

FIGS. 1a to 1d illustrate four example configurations of a first sheet 21, which are different from each other in the proportion of a transparent portion 21a and a non-transparent portion 21b.

In the first sheet 21 of FIG. 1a, the transparent portion 21a is smaller than the non-transparent portion 21b. On the other hand, in the first sheet 21 of FIG. 1b, the transparent portion 21a is larger than the non-transparent portion 21b.

Further, in the first sheet 21 of FIG. 1c, the transparent portion 21a is substantially equal to the non-transparent portion 21b. The first sheet 21 of FIG. 1d may have only the transparent portion 21a.

When an image forming apparatus is used, the first sheet 21 as illustrated in FIGS. 1a to 1d may be conveyed in either direction indicated by “x” and “y” in the drawings. For the first sheet 21, the image forming surface of the transparent portion 21a is covered by a transparent adhesive layer. Further, the transparent adhesive layer extends to and covers the image forming surface of the non-transparent portion 21b.

Such a transparent adhesive layer may be configured to have an adhesive force so as not to adhere to a pressing member, such as a roller, only by receiving pressure from the pressing member in an image forming process or a sheet conveyance process in the image forming apparatus.

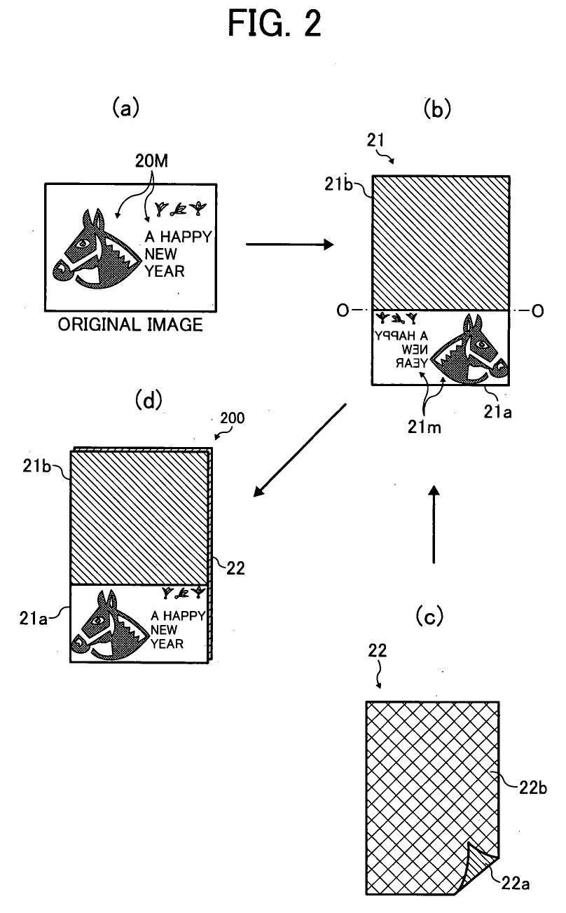

Hereinafter, a method of producing an image recording medium 200 is described with reference to FIGS. 2a to 2d, in which the first sheet 21 having the transparent portion 21a at a lower proportion may be used.

For the first sheet 21 of FIGS. 2a to 2d, each of the transparent portion 21a and the non-transparent portion 21b has one surface fully covered by a transparent adhesive layer.

FIG. 2a illustrates an example of an original image 20M including characters and illustrations. The original image 20M may be included in a document, or may be stored as image data in a storage medium such as a hard disk or a memory card.

FIG. 2b illustrates an example of a first sheet 21 finally forming an image recording medium 200 according to an example embodiment. FIG. 2b also illustrates the reverse side of the first sheet 21, the surface of which is covered by a transparent adhesive layer.

As illustrated in FIG. 2b, an image forming apparatus may form a mirror image 21m of the original image 20M on the transparent portion 21a of the first sheet 21.

FIG. 2c illustrates an example of the second sheet 22 used for the image recording medium 200.

As illustrated in FIG. 2c, the second sheet 22 is a non-transparent sheet, and is similar, if not same, in size to the first sheet 21.

The second sheet 22 may have a front side 22b and a reverse side 22a as shown in FIG. 2c.

The reverse side 22a of the second sheet 22 forms a reverse side of the image recording medium 200, while the front side 22b of the second sheet 22 forms a background of the mirror image 21m in the image recording medium 200. Therefore, the front side 22b of the second sheet 22 is preferably formed in a color distinguishable from a color of the mirror image 21m.

For this reason, in example embodiments, the front side 22b may be formed in white although the front side 22b is illustrated in pattern in FIG. 2c for clarity. However, the front side 22b may be formed in any color as long as the front side 22b is distinguishable from the mirror image 21m.

Subsequently, the second sheet 22 of FIG. 2c is overlaid on the first sheet 21 of FIG. 2b so that the front side 22b faces the mirror image 21m. Pressure and, if needed, heat is applied to the first sheet 21 and the second sheet 22. Thereby, the second sheet 22 is adhered to the transparent adhesive layer of the first sheet 21. Thus, the first sheet 21 and the second sheet 22 are integrated together.

When the integrated sheets 21 and 22 are inverted, the image recording medium 200 having a glossy photographic image is visible as illustrated in FIG. 2d.

That is, when viewing the image recording medium 200 from the front side, the mirror image 21m is visible through the transparent portion 21a as a normal image. Further, the front surface of the non-transparent portion 21b illustrated in FIG. 2d forms a blank portion of the image recording medium 200. A user can write or print information on the front surface of the non-transparent portion 21b.

Instead of using the second sheet 22 illustrated in FIG. 2c, the reverse side of the non-transparent portion 21b may be folded over the reverse side of the transparent portion 21a along a line O-O. Thus, the non-transparent portion 21b is also overlaid on the transparent portion 21a, which can produce a glossy image. In such a case, the reverse side of the non-transparent portion 21b may be formed in a color distinguishable from a color of the mirror image 21m because the reverse side finally forms the background of the mirror image 21m in the image recording medium 200.

In the image recording medium 200 thus produced, the mirror image 21m may be sandwiched by the transparent portion 21a and the second sheet 22 or the non-transparent portion 21b, by which the mirror image 21m may be preserved in good condition for a relatively period of time.

Further, because the front surface of the transparent portion 21a is glossy, the mirror image 21m is visible as a glossy photographic image when viewing the image recording medium 200 from the front side as illustrated in FIG. 2d.

Because the above-mentioned mirror image 21m may be easily formed with a conventional image forming apparatus, the image recording medium 200 may be easily produced.

The first sheet 21 may be formed of material having a relatively low transmittance of ultraviolet rays. In such a case, even if the image recording medium 200 is left to be exposed to direct sunlight, for example, as an outdoor poster or panel, the image recording medium 200 is capable of suppressing damage that ultraviolet rays may cause to a mirror image 21m, the second sheet 22, etc.

In example embodiments, the first sheet 21 has a transmittance of ultraviolet rays of 50% or less to suppress damages to the mirror image 21m or the like. The lower transmittance the first sheet 21 has, the more significantly the first sheet 21 suppresses such damage.

There are at least two methods of forming the mirror image 21m of original image 20M on the transparent adhesive layer of the first sheet 21.

One method employs a toner transfer technology. In example embodiments, an electrophotographic image forming apparatus transfers a toner image on the transparent adhesive layer of the first sheet 21 to form the mirror image 21m.

Another method employs an inkjet printing technology. In example embodiments, an image forming apparatus employing an inkjet printing technology ejects ink droplets to form the mirror image 21m on the transparent adhesive layer of the first sheet 21.

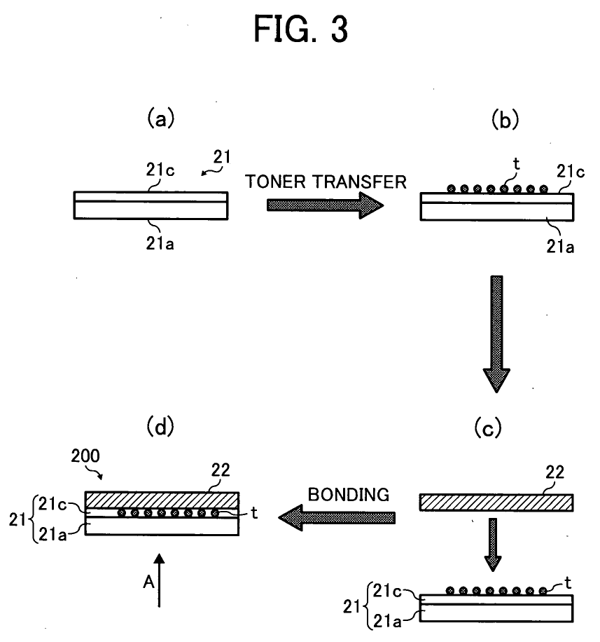

FIGS. 3a to 3d schematically illustrate an example process of producing an image recording medium 200 including a glossy photographic image using a toner transfer technology when a first sheet 21 is totally transparent.

As illustrated in FIGS. 3a to 3d, the first sheet 21 includes a transparent portion 21a and a transparent adhesive layer 21c. An image forming surface of the transparent portion 21a is fully covered by the transparent adhesive layer 21c.

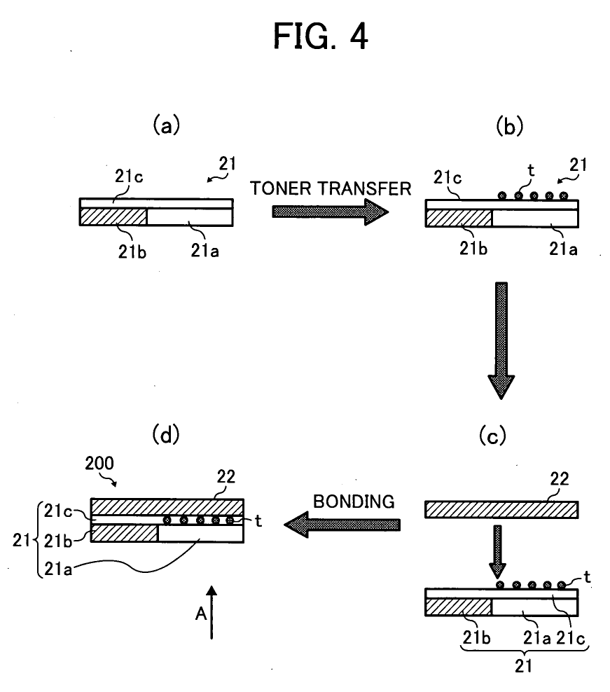

FIGS. 4a to 4d schematically illustrate an example process of producing an image recording medium 200 including a glossy photographic image using a toner transfer technology when a first sheet 21 is partially transparent.

As illustrated in FIGS. 4a to 4d, the first sheet 21 includes a transparent portion 21a, a non-transparent portion 21b, and a transparent adhesive portion 21c. Each image forming surface of the transparent portion 21a and the non-transparent portion 21b is covered by the transparent adhesive portion 21c.

As illustrated in FIGS. 3a and 4a, the first sheet 21 is set to a sheet feeding cassette or a manual sheet feed tray of an image forming apparatus. A condition that the first sheet 21 has a transparent portion may be instructed to the image forming apparatus as below.

In this regard, a user may specify such a condition when selecting a sheet feeding manner. Alternatively, a user may select a registered setting of a recording medium having a transparent portion of a certain size.

In this way, an image forming area on the first sheet 21 may be specified.

If the image forming apparatus determines that the original image can be formed in a range of the specified image forming area on the transparent layer 21a, the image forming apparatus automatically executes data processing of inverting the original image by an image inverting function. The image forming apparatus forms a mirror image of the original image with toner “t” at the specified image forming area on the transparent portion 21a, as illustrated in FIGS. 3b and 4b.

A second sheet 22 is fed from a sheet feed unit to a sheet conveyance path in synchronization with a timing at which the first sheet 21 is conveyed thereto. Thus, the second sheet 22 is overlaid on the transparent adhesive layer 21c of the first sheet 21, as illustrated in FIGS. 3c and 4c.

The first sheet 21 and the second sheet 22, which are overlaid together to sandwich the toner image, pass through a fixing unit for applying pressure without heating. Thereby, the first sheet 21 and the second sheet 22 are firmly bonded together to be integrated as illustrated in FIGS. 3d and 4d.

When seen from the direction indicated by an arrow A in FIGS. 3d and 4d, the toner image thus formed is visible as a normal image similar to the original image, as illustrated in FIG. 2d. Thus, a photographic image can be obtained in a relatively simple manner.

Further, the image forming surface, e.g., the transparent adhesive layer 21c, is sandwiched by the transparent portion 21a and the second sheet 22. Such a configuration can suppress damage or scratches of the image forming surface that may be caused by an external force.

Thus, the toner image in the image recording medium 200 may be preserved in good condition for a relatively period of time.

For the fixing operation in the process as described above, the fixing of the toner image and the bonding of the first sheet 21 and the second sheet 22 via the transparent adhesive layer 21c are simultaneously performed by only applying pressure without heating. Thus, the above-described method may simplify the fixing process and may save a relatively large amount of power.

Although such non-heating fixing manner may be advantageous in a monochromatic image forming, such non-heating fixing manner may not be preferable for color image forming as below.

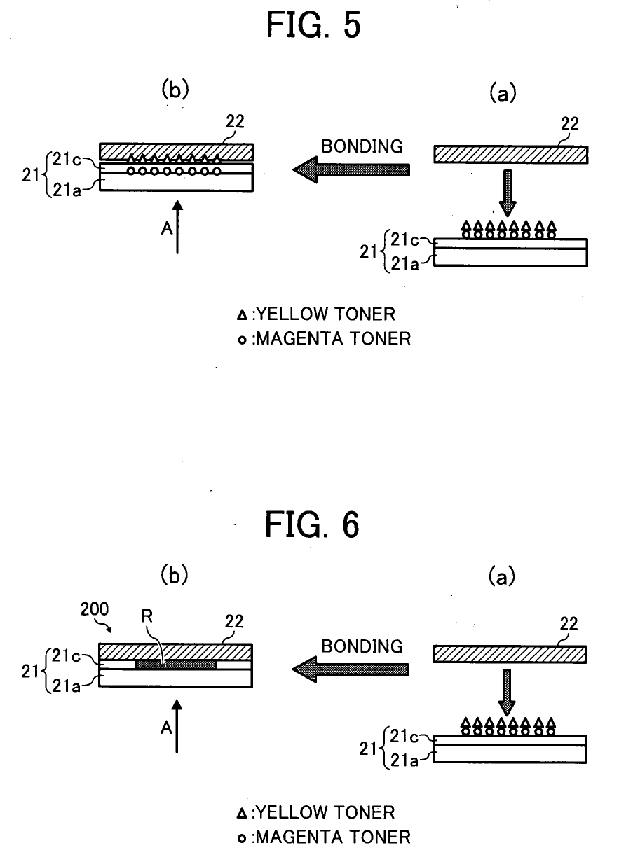

For example, FIG. 5a illustrates a case where a color image is formed with yellow toner and magenta toner on the transparent adhesive layer 21c of the first sheet 21 and is fixed by only applying pressure without heating.

In such a case, as illustrated in FIG. 5b, the yellow toner and the magenta toner may not be sufficiently fused and mixed with each other. Further, the yellow toner and the magenta toner may not exhibit bright coloration.

Further, when toner particles thickly aggregate at a spot on a bonding surface between the first sheet 21 and the second sheet 22, the adhesive force of the spot may be lowered, thus deteriorating the image stability of the toner image in the image recording medium.

Hence, according to an example embodiment, when a color image is formed on the first sheet 21, pressure and heat may be applied to the first sheet 21 and the second sheet 22.

FIGS. 6a and 6b illustrate an example process of producing an image recording medium including a glossy photographic image by applying pressure and heating in a color image forming apparatus.

In FIG. 6a, a color image is formed with yellow toner and magenta toner on a transparent adhesive layer 21c of a first sheet 22, and is fixed by applying pressure and heat.

In such a case, as illustrated in FIG. 6b, yellow toner and magenta toner are fused and mixed with each other, thereby exhibiting red color. In the fixing operation, applying heat, as well as pressure, causes the yellow toner and the magenta toner to fuse, so that the first sheet 21 and the second sheet 22 are bonded together. Thus, even at a spot where toner particles thickly aggregate on the transparent adhesive layer 21c of the first sheet 21, strong adhesive force of the first sheet 21 with the second sheet 22 can be obtained.

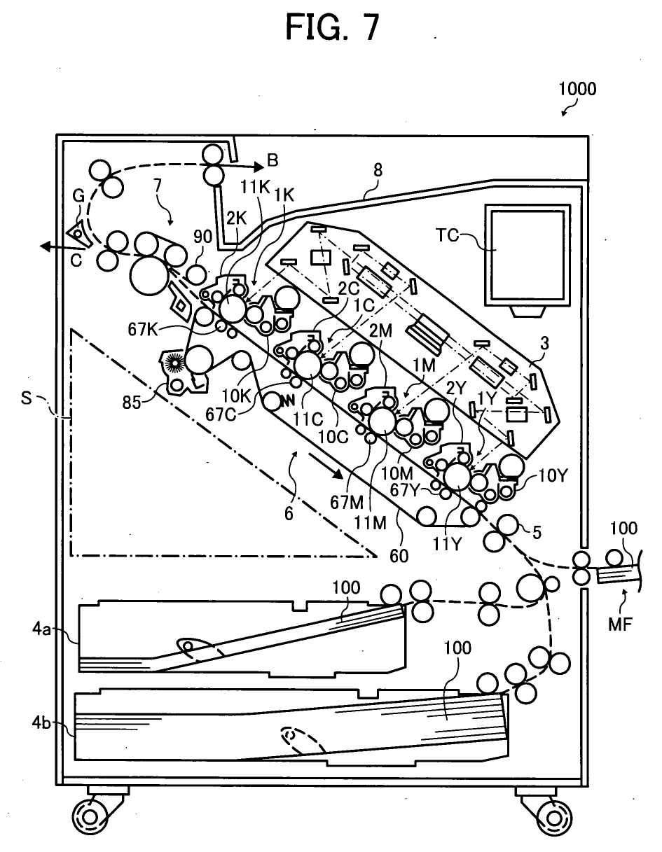

FIG. 7 is a schematic configuration view illustrating an example of an electrophotographic image forming apparatus 1000 usable to produce an image recording medium including a photographic image according to an example embodiment.

The electrophotographic image forming apparatus 1000 includes four image forming units 1Y, 1M, 1C, and 1K usable to form images in yellow (Y), magenta (M), cyan (C), and black (K), respectively. In example embodiments, the image forming units 1Y, 1M, 1C, and 1K are arranged in this order along a direction in which a transfer sheet 100 is conveyed. However, the image forming units 1Y, 1M, 1C, and 1K may be arranged in a different order.

The image forming units 1Y, 1M, 1C, and 1K include photosensitive drums 11Y, 11M, 11C, and 11K, respectively, serving as image carriers. Each of the image forming units 1Y, 1M, 1C, and 1K also includes a charger, a developing unit, and a cleaner. The image forming units 1Y, 1M, 1C, and 1K are positioned so that respective rotational shafts of the photosensitive drums 11Y, 11M, 11C, and 11K are parallel relative to each other and are arranged at a certain interval along the direction in which a transfer sheet 100 is conveyed.

Above the image forming units 1Y, 1M, 1C, and 1K is disposed an optical writing unit 3. The optical writing unit 3 includes a light source, a polygon mirror, an f-θ lens, a reflective mirror, etc. The optical writing unit 3 serves as an irradiator for irradiating laser beams on respective surfaces of the image forming units 1Y, 1M, 1C, and 1K.

Below the image forming units 1Y, 1M, 1C, and 1K is disposed a transfer unit 6. The transfer unit 6 serves as a belt drive device including a conveyance belt 60. The conveyance belt 60 carries and conveys the transfer sheet 100 so that the transfer sheet 100 passes through respective transfer sections of the image forming units 1Y, 1M, 1C, and 1K.

Along an outer surface of the conveyance belt 60 is disposed a cleaning unit 85. The cleaning unit 85 includes a brush roller and a cleaning blade, and cleans excess toner or other excess material remaining on the transfer conveyance belt 60.

On an upper portion of the image forming apparatus 1000 are disposed a fixing unit 7, an ejection tray 8, a sheet feeding unit 90, a toner container TC, or other components. On the lower portion of the image forming apparatus 1000 are disposed sheet feeding cassettes 4a and 4b usable to store a plurality of transfer sheets 100. Further, at one lateral side of the image forming apparatus 1000 is provided a manual sheet feeding tray MF usable to manually feed a transfer sheet 100.

The image forming apparatus 1000 also includes, in a space S indicated by a chain double-dashed line in FIG. 7, a waste toner bottle, a duplex transfer unit, a power supply unit, etc.

Developing units 10Y, 10M, 10C, and 10K are similar, if not same, in configuration to each other. In example embodiments, the developing units 10Y, 10M, 10C, and 10K accommodate two-component developing agent including toner particles and magnetic carrier particles. The developing units 10Y, 10M, 10C, and 10K are different from each other in the colors of toner particles.

Each of the developing units 10Y, 10M, 10C, and 10K includes a developing roller that is disposed to face the corresponding one of the photosensitive drums 11Y, 11M, 11C, and 11K. Each developing unit 10Y, 10M, 10C, and 10K also includes a screw usable to convey and stir the developing agent, a toner density sensor, or other components.

The developing roller includes an outer rotatable sleeve and an inner fixed magnet. To the developing roller, the developing agent including toner particles is supplied from a toner supply unit corresponding to an output signal of the toner density sensor.

Next, an image forming operation is described with respect to the image forming unit 1Y. However, image forming operations of the image forming unit 1M, 1C, and 1K are similar, if not same, to the operation of the image forming unit 1Y. Therefore, repeated descriptions are omitted in the following description.

A power source (not illustrated) applies a certain amount of voltage to a charging roller of the charger. Thereby, the photosensitive drum 11Y, disposed to face the charging roller, is charged. When the photosensitive drum 11Y is charged to a certain amount of electric potential, the optical writing unit 3 irradiates a laser beam based on image data to form an electrostatic latent image on the surface of the photosensitive drum 11Y.

When the electrostatic latent image on the surface of the photosensitive drum 11Y reaches the position of the developing unit 10Y, the developing roller supplies the developing agent, including toner particles, to the electrostatic latent image on the surface of the photosensitive drum 11Y. Thus, a toner image is formed on the surface thereof.

The above image forming operation is similarly performed in each of the image forming units 1M, 1C, and 1K at separate timings. Thus, toner images of different colors are formed on the respective surfaces of the photosensitive drums 11Y, 11M, 11C, and 11K.

Further, a transfer sheet 100 is conveyed from one of the sheet feeding cassettes 4a and 4b and the manual sheet feeding tray MF. Reaching a registration roller pair 5, the transfer sheet 100 is temporarily stopped.

In accordance with appropriate timings of image forming operations in the photosensitive units 2Y, 2M, 2C, and 2K, the transfer sheet 100 is fed out by the registration roller 5, and is conveyed along the photosensitive units 2Y, 2M, 2C, and 2K by the transfer conveyance belt 60. Thus, the toner images on the photosensitive units 2Y, 2M, 2C, and 2K are sequentially transferred on the transfer sheet 100.

For example, for the image forming unit 1Y, the transfer operation of toner image to the transfer sheet 100 is performed by applying a voltage to a primary transfer roller 67Y, which is disposed to face the photosensitive 11Y. In this regard, the voltage has a polarity opposite to a polarity of the toner particles on the photosensitive drum 11Y.

The transfer operation of toner image is similarly performed in the image forming units 1M, 1C, and 1K, in turn.

When the transfer sheet 100 is passed through a nip portion between the photosensitive drum 11K and a primary transfer roller 67K, the transfer sheet 100 is further conveyed to the fixing unit 7. The fixing unit 7 applies pressure and heat to the transfer sheet 100 to fix the toner images.

After the fixing operation, the conveyance path of the transfer sheet 100 is switched by a switching member G into a lateral direction indicated by an arrow C or a direction indicated by an arrow B toward the ejection tray 8 in FIG. 7.

Although the image forming apparatus 1000 according to an example embodiment may have an internal configuration as shown in FIG. 7, other internal configuration may be employed for the image forming apparatus 1000, as required.

For example, the image forming apparatus 1000 may include four photosensitive drums that are configured in a revolving manner rather than being tandemly arranged. Alternatively, the image forming apparatus may be a monochrome image forming apparatus rather than a color image forming apparatus.

The image forming apparatus may also employ an LED (light emitting diode) instead of a laser beam as a light source in the optical writing unit. Further, the image forming apparatus may develop an electrostatic latent image with one-component developing agent rather than two-component developing agent.

When the image forming apparatus 1000, as described above, is used to produce an image recording medium including a glossy photographic image, the first sheet 21 is used instead of the transfer sheet 100.

Similar to the case of the transfer sheet 100, the transfer operation, as described above, is performed in the image forming units 1Y, 1M, 1C, and 1K in turn. Thereby, a color toner image is formed as a mirror image of the original image on a transparent portion 21a of the first sheet 21.

After the first sheet 21 is passed through the transfer section of the photosensitive drum 11K, the sheet feeding unit 90 feeds the second sheet 22 to a sheet conveyance path in synchronization with a timing in which the first sheet 21 is conveyed thereto. Thus, the second sheet 22 is overlaid on the transparent portion 21a of the first sheet 21 before the first sheet 21 reaches the fixing unit 7.

The fixing unit 7 applies heat and pressure to the first sheet 21 and the second sheet 22. Thereby, the first sheet 21 and the second sheet 22 are integrated to form an image recording medium including a photographic image. The image recording medium is ejected to the ejection tray 8.

Alternatively, when a monochrome image forming apparatus is used to form an image recording medium including a photographic image, the monochrome image forming apparatus may fix the first sheet 21 and the second sheet 22 by applying pressure and heat thereto or by applying only pressure.

Next, a process of forming a mirror image of an original image on the transparent portion 21a of the first sheet 21 is described.

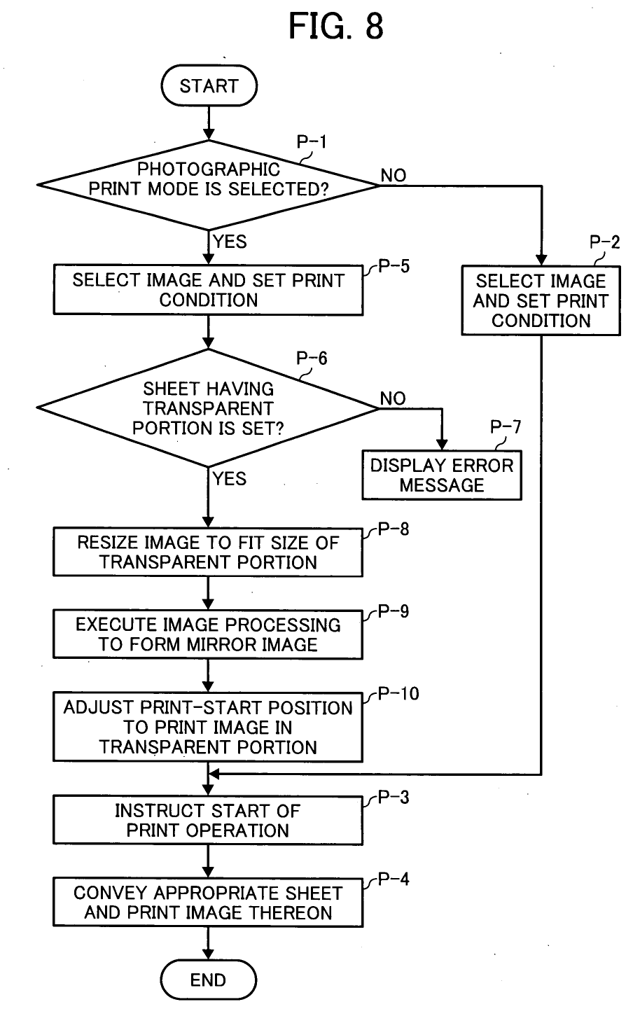

In the image forming apparatus 1000 of example embodiments, the process of forming a mirror image is executed according to a procedure as illustrated in FIG. 8 by a program implemented in the controller of the image forming apparatus 1000.

For example, at P-1, if the program determines that a photographic print mode is not selected (“NO” at P-1), the processing goes to P-2.

At P-2, the program selects an original image to be printed, and sets print conditions.

At P-3, the program instructs the start of a print operation of the selected image.

At P-4, an appropriate transfer sheet for the purpose of printing is conveyed, and a toner image is formed on the transfer sheet at a position and with a resolution in accordance with the print conditions.

Alternatively, at P-1, if the program determines that the photographic print mode is selected (“YES” at P-1), the processing goes to P-5.

At P-5; the program selects an image to be printed and sets print conditions.

At P-6, the program determines whether or not a recording medium having a transparent portion is set in a sheet feeding cassette or a manual sheet feeding tray.

If the program determines that such a recording medium is not set in a sheet feeding cassette or a manual sheet feeding tray (“NO” at P-6), the program instructs the display of an error message.

On the other hand, if the program determines that such a recording medium is set in a sheet feeding cassette or a manual sheet feeding tray (“YES” at P-7), the processing goes to P-8. At P-8, the size of the selected image is enlarged or reduced to fit the size of the transparent portion 21a of the first sheet 21.

At P-9, the program executes data processing to form a mirror image of the selected image on the transparent portion 21a of the first sheet 21.

At P-10, the program adjusts the write start position of the mirror image so that the mirror image is formed within a range of the transparent portion 21a.

The process goes to P-3. At P-3 and P-4, the above-described processing is similarly executed.

Thus, the program implemented in the controller executes the process of forming a mirror image of an original image on the transparent portion 21a of the first sheet 21.

Next, a process of producing an image recording medium including a glossy photographic image using an inkjet printing technology is described below.

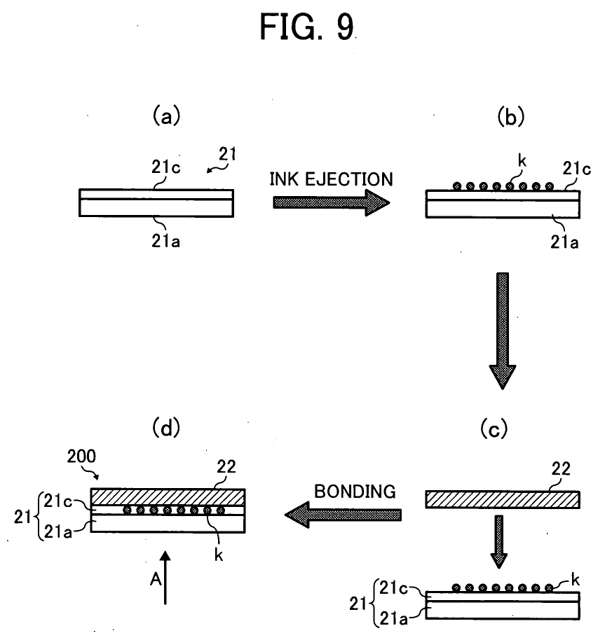

FIGS. 9a to 9d illustrate an example process of producing an image recording medium 200 including a glossy photographic image using an inkjet printing technology when a first sheet 21a is totally transparent.

As illustrated in FIGS. 9a to 9d, the first sheet 21 includes a transparent portion 21a and a transparent adhesive layer 21c. An image forming surface of the transparent portion 21a is fully covered by the transparent adhesive layer 21c.

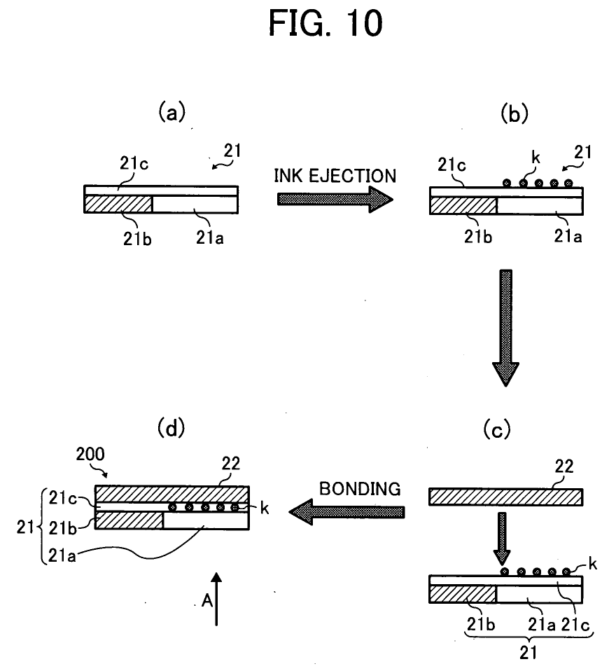

FIGS. 10a and 10d illustrate an example of a process of producing an image recording medium 200 including a glossy photographic image using an inkjet printing technology when a first sheet 21 partially has a transparent portion.

As illustrated in FIGS. 10a to 10d, the first sheet 21 includes a transparent portion 21a, a non-transparent portion 21b, and a transparent adhesive portion 21c. Each image forming surface of the transparent portion 21a and the non-transparent portion 21b is covered by the transparent adhesive portion 21c.

The first sheet 21 as illustrated in FIGS. 9a and 10a is set in a sheet feeding cassette or a manual sheet feed tray in an image forming apparatus. A condition that the first sheet 21 has a transparent portion is specified in the image forming apparatus. In this regard, a user may specify such a condition when selecting a sheet feeding manner. Alternatively, a user may select a registered setting of a recording medium having a transparent portion of a certain size.

In this way, an image forming area is specified for an original image to be printed. If the image forming apparatus determines that the original image can be formed in a range of the specified image forming area on the transparent layer 21a, the image forming apparatus automatically executes data processing of inverting the original image by an image inverting function. The image forming apparatus forms a mirror image of the original image with ink “k” in the specified image forming area on the transparent portion 21a, as illustrated in FIGS. 9b and 10b.

A second sheet 22 is fed from a sheet feeding unit to the sheet conveyance path in synchronization with a timing at which the first sheet 21 is conveyed thereto. Thus, the second sheet 22 is overlaid on the transparent adhesive layer 21c of the first sheet 21, as illustrated in FIGS. 9c and 10c.

The first sheet 21 and the second sheet 22, which are overlaid together to sandwich the toner image, are bonded together by receiving pressure to be integrated as illustrated in FIGS. 9d and 10d.

When seen from the direction indicated by an arrow A in FIGS. 9d and 10d, the image thus formed with ink “k” is visible as a normal image similar to the original image, as illustrated in FIG. 2d. Thus, a photographic image can be obtained in a relatively simple manner.

Further, the image forming surface, e.g., the transparent adhesive layer 21c, is sandwiched by the transparent portion 21 and the second sheet 22. Such a configuration may suppress damage or scratches on the image forming surface that may be caused by an external force. Thus, improved image stability may be obtained for the image formed in the recording medium.

As described above, in example embodiments, a photographic image is formed using an inkjet printing technology. An image forming apparatus using such an inkjet printing technology is generally inexpensive compared to other types of image forming apparatuses. Therefore, according to the process of example embodiments, a personal or home user can obtain a photographic image having improved image stability at reasonable cost.

However, when an image forming apparatus, such as a typical inkjet printer, is used, ejection of a relatively large amount of ink “k” on a spot of the transparent portion 21a of the first sheet 21 may reduce the adhesive force of the spot with the second sheet 22.

Such adhesive force may be enhanced if ink having a relatively higher adhesive force is used for image forming.

Further, such highly adhesive ink may bond also the first sheet 21 and the second sheet 22 with a relatively strong adhesive force even if some spot may have a relatively large amount of ink. Such highly adhesive ink may be available from a certain manufacture.

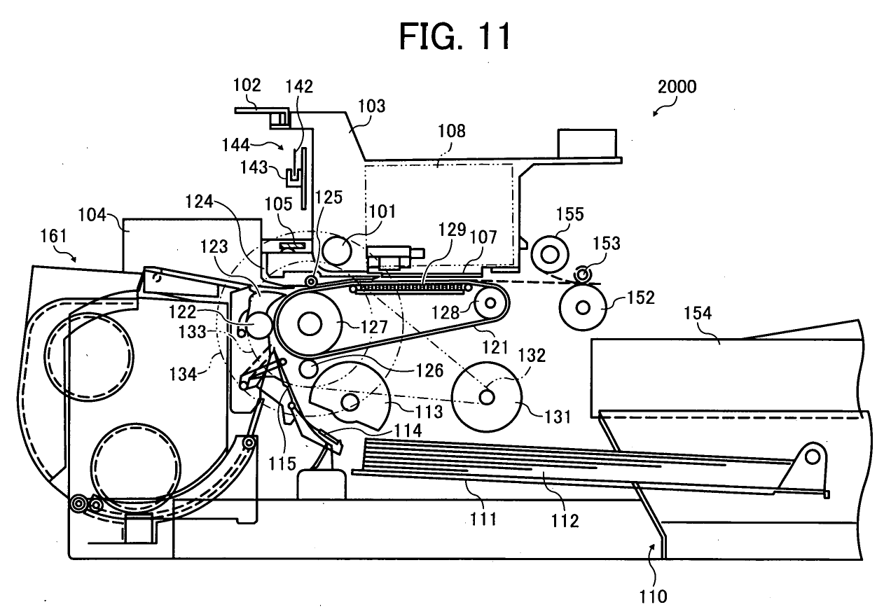

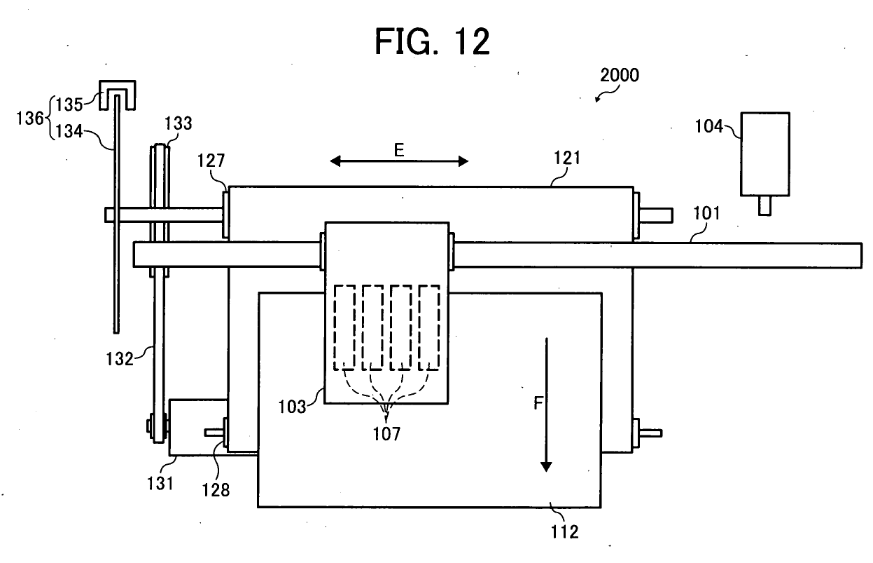

Next, an image forming apparatus usable to produce an image recording medium to an example embodiment is described with reference to FIGS. 11 and 12.

FIG. 11 is a side view illustrating an image forming apparatus 2000 using an inkjet printing technology. FIG. 12 is a plan view illustrating a main part of the image forming apparatus 2000 of FIG. 11.

As illustrated in FIG. 10, the image forming apparatus 2000 may include a guide rod 101, a guide rail 102, a carriage 103, a main-scan motor 104, and a timing belt 105.

The carriage 103 is slidably supported on the guide rod 101 and the guide rail 102. The carriage 103 is driven by the main-scan motor 104 via the timing belt 105 to move in the main scanning directions indicated by a double-arrow E in FIG. 12.

The carriage 103 may include a recording head 107 having, for example, four ink-ejection heads for ejecting ink droplets of respective colors of yellow, cyan, magenta, and black. The recording head 107 is positioned so that the respective ink-ejection heads eject the ink droplets downwardly. Further, the recording head 107 may be positioned so that multiple nozzles thereof are arranged along a direction perpendicular to the main scan directions.

A piezoelectric actuator, such as a piezoelectric element, is used in each of the ink-ejection heads forming the recording head 107.

The carriage 103 is provided with four sub-reservoirs 108 for supplying respective color inks to the recording head 107. To the sub-reservoirs 108, respective color inks are supplied from the corresponding main reservoirs, e.g., ink cartridges through ink supply tubes.

In example embodiments, the sub-reservoirs 108 and the recording head 107 form an ink ejection device. However, the recording head 107 and the sub-reservoirs 108 may be separately configured. Alternatively, the recording head 107 may form the ink ejection device along with the ink cartridges, instead of the sub-reservoirs 108.

The image forming apparatus 2000 also includes a sheet feeding cassette 110. The sheet feeding cassette 110 is provided with a sheet loading portion 111 for loading a stack of recording sheets 112.

Further, the image forming apparatus 2000 includes a sheet feeding section for feeding a recording sheet 112, loaded on the sheet loading portion 111, sheet by sheet. The sheet feeding section is provided with a sheet feeding roller 113 and a separation pad 114.

The sheet feeding roller 113 separates a single recording sheet 112 from the stack of recording sheets 12 and feeds the single recording sheet 112 toward the separation pad 114. The separation pad 114 is formed of material having relatively high friction coefficient. The separation pad 114 is disposed to face the sheet feeding roller 113 and is biased toward the sheet feeding roller 113.

Further, the image forming apparatus 2000 includes a conveyance section for conveying the recording sheet 112, which is fed from the sheet feeding section, to the underside of the recording head 107. The conveyance section may include a conveyance belt 121, a counter roller 122, a conveyance guide 123, a pressing roller 125, and a charging roller 126.

The conveyance belt 121 electrostatically attracts and conveys the recording sheet 112, which is fed along a guide 115 from the sheet feeding section. The counter roller 122 sandwiches and conveys the recording sheet 112 along with the conveyance belt 121. The conveyance guide 123 turns the conveyance direction of the recording sheet 112, which is conveyed substantially vertically upward, approximately 90 degrees. The pressing roller 125 is biased by a pressing member 124 toward the conveyance belt 121. The charging roller 126 charges the surface of the conveyance belt 121.

The conveyance section may also include a conveyance roller 127, a tension roller 128, a guide member 129, a sub-scanning motor 131, a timing belt 132 and a timing roller 133.

As illustrated in FIG. 11, the conveyance belt 121 may be an endless belt that is stretched over the conveyance roller 127 and the tension roller 128. A rotation of the sub-scanning motor 131 causes a corresponding rotation of the conveyance roller 127 via the timing belt 132 and the timing roller 133. The rotation of the conveyance roller 127 subsequently causes the conveyance belt 121 to move around in the sheet conveyance direction, e.g., the sub-scanning direction indicated by an arrow F in FIG. 12.

The guide member 129 is disposed along an inner surface of the conveyance belt 121 so as to correspond with the image forming area of the recording head 107.

As illustrated in FIG. 12, a slit disk 134 is mounted on a shaft of the conveyance roller 127. Adjacent to the slit disk 134 is disposed a sensor 135 for detecting a slit of the slit disk 34. The slit disk 134 and the sensor 135 form an encoder 136.

The charging roller 126 is disposed to contact an outer surface of the conveyance belt 121 and rotate in accordance with the rotation of the conveyance belt 121. As a pressing force, a load of 2.5N is applied to each end of a shaft of the charging roller 126.

Furthermore, the image forming apparatus 2000 may include an encoder 144 usable to detect a position of the carriage 103 in the main-scanning directions. The encoder 144 may further include an encoder scale 142 and an encoder sensor 143.

The encoder scale 142 is provided with multiple slits and is disposed near the carriage 103. The encoder sensor 143 includes a transmission photosensor usable to detect the slits of the encoder scale 142, and is disposed adjacent to the encoder scale 142.

Moreover, the image forming apparatus 2000 includes an output section for outputting the recording sheet 112, which has been subjected to a printing operation of the recording head 107. The output section includes a separation unit, output rollers 152 and 153, and an output tray 154.

The separation unit, not illustrated, separates the recording sheet 112 from the conveyance belt 121. The output tray 154 stores the recording sheet 112, which is output by rotation of the output rollers 152 and 153.

Incidentally, separately from the above-described sheet feeding section, a sheet feeding unit 155 is provided near the output roller 153. As described above, when a first sheet and a second sheet are used to produce an image recording medium 200 including a photographic image, the sheet feeding unit 155 feeds the second sheet so that the second sheet is overlaid on a transparent adhesive layer of a transparent portion 21a of the first sheet 21. The sheet feeding unit 155 may be configured to be detachably mounted to the image forming apparatus 2000.

Further, a double-sided sheet feeding unit 161 may be detachably mounted to the rear portion of the image forming apparatus 2000. When the recording sheet 112 is conveyed to the double-sided sheet feeding unit 161 by a reverse rotation of the conveyance belt 121, the double-sided sheet feeding unit 161 reverses the recording sheet 112. The double-sided sheet feeding unit 161 re-feeds the recording sheet 112 to a nip portion between the counter roller 22 and the conveyance belt 121.

In the image forming apparatus 2000 thus configured, the recording sheet 112 is fed from the sheet feeding section, is guided by the guide 115, and is sandwiched by the conveyance belt 121 and the counter roller 122. The recording sheet 112 is guided by the conveyance guide 123, and is pressed against the conveyance belt 121 by the pressing roller 125. Thereby, the conveyance direction of the recording sheet 112 is turned approximately 90 degrees.

A control circuit instructs a high-voltage power source to alternately apply a positive voltage and a negative voltage to the charging roller 126. Thus, the conveyance belt 121 is alternately charged with a certain width of positive and negative voltages.

When the recording sheet 112 is fed to the conveyance belt 121 alternately charged with positive and negative voltages, the recording sheet 112 is attracted to the conveyance belt 121 by an electrostatic force. The recording sheet 112 is conveyed in the sub-scanning direction with the circular movement of the conveyance belt 121.

Further, the image forming apparatus 2000 drives the recording head 107 in response to image signals while moving the carriage 103. The image forming apparatus 2000 causes the recording head 107 to eject ink droplets to the recording sheet 112, which is temporarily stopped. Thus, an image of one line is recorded on the recording sheet 112.

After the recording sheet 112 is fed by a certain amount, the image forming apparatus 2000 starts recording an image of another line. When receiving a given or a predetermined recording signal or a signal indicating that a rear end of the recording sheet 112 reaches the recording position of the recording head 107, the image forming apparatus 2000 finishes the recording operation, and outputs the recording sheet 112 to the output tray 154.

In example embodiments, the image forming apparatus usable to produce an image recording medium including a photographic image is described as an inkjet printer. However, the image forming apparatus may be a facsimile machine, a copier, and a multi-function device thereof including an inkjet printer. Further, the image forming apparatus may include a droplet ejection head or a droplet ejection device usable to eject liquid other than ink, such as DNA sample, resist material and pattern material.

Furthermore, when the above-described image forming apparatus 2000 is used to produce an image recording medium including a photographic image, the first sheet 112, as described above, is used instead of the recording sheet 112.

The recording head 107 ejects droplets of ink “k” to the transparent portion 21a of the first sheet 21. Thus, a mirror image of an original image is formed on the first sheet 21.

After passing under the recording head 107, the first sheet 21 is overlaid with the second sheet 22, which is fed out from the sheet feeding unit 155, before reaching the output roller 153. The first sheet 21 and the second sheet 22 are bonded together by receiving pressure at a nip portion between the output rollers 152 and 153.

Thus, the first sheet 21 and the second sheet 22 integrally form an image recording medium 200. The image recording medium 200 is output to the output tray 154.

For the image forming apparatus 2000, the process of forming a mirror image on the transparent portion 21a is executed by a program implemented in the controller of the image forming apparatus 2000. The process is also executed according to a similar procedure to the procedure illustrated in FIG. 8.

Example embodiments of the present patent application may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. Example embodiments of the present patent application may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that, within the scope of the appended claims, the disclosure of this patent specification may be practiced otherwise than as specifically described herein.

Further, elements and/or features of different example embodiments may be combined with each other and/or substituted for each other within the scope of this disclosure and appended claims.

Still further, any one of the above-described and other example features of the present patent specification may be embodied in the form of an apparatus, method, system, computer program and computer program product. For example, the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to perform the method of any of the above-mentioned example embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetic storage media, including but not limited to floppy disks™, cassette tapes, and removable hard disks; media with a built-in rewriteable non-volatile memory, including but not limited to memory cards; and media with a built-in ROM, including but not limited to ROM cassettes, etc. Furthermore, various information regarding stored images, for example, property information, may be stored in any other form, or provided in other ways.

Example embodiments being thus described, it will be obvious that the same may be varied in many ways. Such variations are not to be regarded as a departure from the spirit and scope of the present patent application, and all such modifications as would be obvious to one skilled in the art are intended to be included within the scope of the following claims.

What is claimed is:

1. An image recording medium, comprising:
a first sheet including a transparent portion having a transparent adhesive layer, a mirror image of an original image being formed on the transparent adhesive layer; and
a second sheet formed of non-transparent material having a color distinguishable from a color of the mirror image, the second sheet being overlaid on the transparent adhesive layer, having the mirror image formed thereon, of the first sheet.

2. The image recording medium of claim 1, wherein the first sheet includes only the transparent portion.

3. The image recording medium of claim 1, wherein the first sheet further includes a non-transparent portion.

4. The image recording medium of claim 3, wherein the transparent portion is a different size than the non-transparent portion.

5. The image recording medium of claim 3, wherein the transparent portion is the same size as the non-transparent portion.

6. The image recording medium of claim 1, the first sheet having a light transmittance of 50 percent or less in an ultraviolet wavelength range.

7. The image recording medium of claim 1, wherein a reverse side of the second sheet forms a reverse side of the image recording medium and a front side of the second sheet forms a background of a mirror image of the image recording medium.

8. The image recording medium of claim 7, wherein the second sheet is overlaid on the first sheet so that the front side faces the mirror image.

9. The image recording medium of claim 7, wherein the non-transparent portion is overlaid on the transparent portion.

10. The image recording medium of claim 7, wherein a reverse side of the non-transparent portion is of a color distinguishable from a color of the mirror image and the reverse side forms the background of the mirror image in the image recording medium.

11. The image recording medium of claim 7, wherein the mirror image is sandwiched by the transparent portion and the second sheet or the non-transparent portion.

12. A method of producing an image recording medium, the method comprising:
providing a first sheet including a transparent portion, the transparent portion having a transparent adhesive layer;
forming a mirror image of an original image on the transparent adhesive layer of the transparent portion of the first sheet;
providing a second sheet formed of non-transparent material having a color distinguishable from a color of the mirror image; and
overlaying the second sheet on the transparent adhesive layer, having the mirror image formed thereon, of the first sheet.

13. The method according to claim 12, wherein in the forming, the mirror image is transferred to the transparent adhesive layer.

14. The method according to claim 13, wherein in the overlaying, the second sheet is bonded to the transparent adhesive layer of the first sheet by applying pressure to any one of the first sheet and second sheet.

15. The method according to claim 13, wherein in the overlaying, the second sheet is bonded to the transparent adhesive layer of the first sheet by applying pressure and heat to any one of the first sheet and second sheet.

16. The method according to claim 12, wherein the mirror image is formed on the transparent adhesive layer by dispensing a liquid agent on the transparent adhesive layer.

17. The method according to claim 16, wherein in the overlaying, the second sheet is bonded to the transparent adhesive layer of the first sheet by applying pressure to at least one of the first sheet and second sheet.

18. The method according to claim 16, wherein the liquid agent has a relatively great adhesiveness.

19. An image forming apparatus, comprising:
an image carrier configured to have an electrostatic latent image of an original image thereon;
an image developer configured to develop the electrostatic latent image with developing agent including toner to form a toner image on the image carrier;
a transfer unit configured to transfer the toner image onto the transparent adhesive layer of the transparent portion of the first sheet according to claim 1 to form the mirror image of the original image;
a feed unit configured to feed the second sheet according to claim 1 so that the second sheet is overlaid on the transparent adhesive layer of the transparent portion of the first sheet; and
a fixing unit configured to fix the mirror image on the first sheet and the second sheet.

20. An image forming apparatus, comprising:
a dispensing unit configured to eject a liquid agent onto the transparent adhesive layer of the transparent portion of the first sheet according to claim 1 to form the mirror image of the original image; and
a feed unit configured to feed the second sheet according to claim 1 so that the second sheet is overlaid on the transparent adhesive layer of the transparent portion of the first sheet.
